(19) United States
(12) Patent Application Publication
(10) Pub. No.: US 2024/0270569 A1
(43) Pub. Date: Aug. 15, 2024

(54) RECOVERY OF A RENEWABLE HYDROGEN PRODUCT FROM AN AMMONIA CRACKING PROCESS

(71) Applicant: Air Products and Chemicals, Inc., Allentown, PA (US)

(72) Inventors: Vincent White, Surrey (GB); Edward Landis Weist, JR., Macungie, PA (US); Andrew Shaw, Sunbury on Thames (GB); Simon Craig Saloway, Surrey (GB)

(73) Assignee: Air Products and Chemicals, Inc., Allentown, PA (US)

(21) Appl. No.: 18/569,450

(22) PCT Filed: Jun. 18, 2021
(86) PCT No.: PCT/US2021/037995

§ 371 Date: Dec. 12, 2023

(51) Int. Cl. C01B 3/04; B01D 53/047; C01B 3/56

(52) U.S. Cl. CPC C01B 3/047; B01D 53/047; C01B 3/56; B01D 2256/16; B01D 2257/102; C01B 2203/043; C01B 2203/0465; C01B 2203/0811; C01B 2203/0833

(57) ABSTRACT

Recovery of a renewable hydrogen product from an ammonia cracking process, in which the cracked gas is purified in a first PSA device and at least a portion of the first PSA tail gas is recycled as fuel to reduce the carbon intensity of the renewable hydrogen product.

### BACKGROUND

Global interest in renewable energy and using this renewable energy to generate green hydrogen has driven the interest in converting the green hydrogen to green ammonia, as ammonia is simpler to transport over distance of hundreds or thousands of miles. Particularly, shipping liquid hydrogen is not commercially possible currently but shipping ammonia, which is in a liquid state, is currently practiced.

For use in a commercial fuel cell, the ammonia must be converted back to hydrogen according to the reaction.

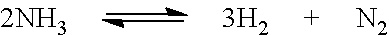

This is an endothermic process, i.e., a process that requires heat, and is performed over a catalyst. This process is known as cracking. The gas produced (or “cracked gas”) is a combination of hydrogen (H₂) and nitrogen (N₂). Since the cracking reaction is an equilibrium reaction, there is also some residual ammonia. In most applications of crackers currently, the hydrogen+nitrogen mixture is utilised as is. However, as ammonia can be a poison to fuel cells, this stream, with ammonia suitably removed such as by scrubbing with water, can be used directly in a fuel cell. However, if the hydrogen is to be used in vehicle fueling, the nitrogen present provides a penalty to the process. The fuel to a vehicle fueling system is compressed to significant pressure—up to 900 bar. This means that the nitrogen, which is merely a diluent in the process, is also compressed, taking power, and taking storage volume and increasing anode gas purge requirement, decreasing efficiency. It is therefore beneficial where hydrogen is to be used in vehicle fueling, for the hydrogen+nitrogen to be purified.

Small scale cracking reactors, or “crackers”, typically use pressure swing adsorption (“PSA”) devices to separate the cracked gas and recover the hydrogen and generate a PSA tail gas (or offgas). However, these crackers are generally heated electrically, and the PSA tail gas is typically vented to atmosphere.

As is common in hydrogen production from a steam methane reforming (SMR) reactor, a PSA can be used to purify the nitrogen+hydrogen. The cracking reaction is performed in tubes packed with catalyst which are externally heated by a furnace (see GB1142941).

GB1142941 discloses a process for making town gas from ammonia. The ammonia is cracked, and the cracked gas scrubbed with water to remove residual ammonia. The purified hydrogen/nitrogen mixture is then enriched with propane and/or butane vapor to produce the town gas for distribution.

U.S. Pat. No. 6,835,360A discloses an endothermic catalytic reaction apparatus for converting hydrocarbon feedstock and methanol to useful gases, such as hydrogen and carbon monoxide. The apparatus comprises a tubular endothermic catalytic reactor in combination with a radiant combustion chamber. The resultant cracked gas is used directly in a fuel cell after passing through a gas conditioning system.

GB977830A discloses a process for cracking ammonia to produce hydrogen. In this process, the hydrogen is separated from the nitrogen by passing the cracked gas through a bed of molecular sieves which adsorbs nitrogen. The nitrogen is then driven off the bed and may be stored in a holder.

JP5330802A discloses an ammonia cracking process in which the ammonia is contacted with an ammonia decomposition catalyst at a pressure of 10 kg/cm² (or about 9.8 bar) and a temperature of 300 to 700° C. Hydrogen is recovered from the cracked gas using a PSA device. The reference mentions that the desorbed nitrogen may be used to boost the upstream process, but no details are provided.

US2007/178034A discloses a process in which a mixture of ammonia and hydrocarbon feedstock is passed through a fired steam reformer at 600° C. and 3.2 MPa (or about 32 bar) where it is converted into a synthesis gas containing about 70 vol. % hydrogen. The synthesis gas is enriched in hydrogen in a shift reaction, cooled and condensate removed. The resultant gas is fed to a PSA system to generate a purified hydrogen product having 99 vol. % hydrogen or more. The offgas from the PSA system is fed as fuel to the fired steam reformer.

CN111957270A discloses a process in which ammonia is cracked in a tubular reactor within a furnace. The cracked gas is separated by adsorption to produce hydrogen gas and a nitrogen-rich offgas. The fuel demand of the furnace appears to be satisfied using a combination of cracked gas, hydrogen product gas and/or offgas.

There is a need generally for improved processes for the production of hydrogen from ammonia and specifically for processes that are more efficient in terms of energy consumption and/or that have higher levels of hydrogen recovery and/or that reduce or eliminate the need to combust fossil fuels.

In the following discussion of embodiments of the present invention, the pressures given are absolute pressures unless otherwise stated.

### BRIEF SUMMARY OF THE INVENTION

According to a first aspect of the present invention, there is provided a process for recovering renewable hydrogen from ammonia that is derived from a source of renewable hydrogen, comprising:
providing a liquid ammonia feed derived from a source of renewable hydrogen;
pressurizing the liquid ammonia feed;
heating (and optionally vaporizing) the liquid ammonia feed by heat exchange with one or more hot fluids to produce heated ammonia;
combusting a primary fuel in a furnace to heat catalyst-containing reactor tubes and to form a flue gas;
supplying the heated ammonia to the catalyst-containing reactor tubes to cause cracking of the ammonia into a cracked gas containing hydrogen gas, nitrogen gas and residual ammonia; and
purifying the cracked gas, or an ammonia-depleted gas derived therefrom, in a first PSA device to produce a first PSA tail gas and a renewable hydrogen product gas comprising a first hydrogen gas;

wherein the one or more hot fluids comprise the flue gas and/or the cracked gas;

wherein the primary fuel is supplemented as required with a secondary fuel comprising at least a portion of the first PSA tail gas and/or a PSA tail gas derived therefrom;

wherein hydrogen is recovered from any remaining portion of the first PSA tail gas to the renewable hydrogen product gas; and

wherein the total carbon intensity value of the process is varied by adjusting the ratio of the secondary fuel to the primary fuel such that the overall carbon intensity value of the renewable hydrogen product gas remains below a pre-determined value.

Carbon intensity (CI) can be defined as the amount of carbon dioxide by weight emitted per unit of energy contained in the renewable hydrogen produced. Specifically, it is reported as gram (g) of carbon dioxide per mega Joule (MJ) of hydrogen (g CO₂/MJ H₂), based on the lower heating value of the renewable hydrogen product. Carbon intensity can be used as a measure of how “green” a fuel is. The total carbon intensity of hydrogen fuel is made up of several parts. These include the carbon intensity related to the conversion of renewable hydrogen into ammonia for transportation; the amount of carbon dioxide associated with shipping and transporting the ammonia feed from the source of the renewable hydrogen to the point at which the renewable hydrogen is liberated from the ammonia carrier by cracking; the fuel required to crack the ammonia; the amount of carbon dioxide associated with the electrical power used to operate the plant; and the amount of carbon dioxide associated with distributing the product hydrogen.

As the carbon intensity of electricity production decreases as more renewable power is added to the grid, and as ships, trucks and other transport reduce their carbon intensity (e.g. by using renewable ammonia as fuel, or hydrogen fuel cells, or batteries charged with renewable electricity), the carbon intensity of hydrogen fuel produced by ammonia cracking will also decrease. As the carbon intensity of the overall chain reduces, the recovery of renewable hydrogen can be increased, thereby reducing the cost of hydrogen whilst allowing control over the carbon intensity value of the renewable hydrogen product.

The expression “total carbon intensity value of the present process” refers to the carbon intensity of the process for recovering renewable hydrogen from ammonia defined by the essential features of the process, and optionally including any or all of the optional features of the process described herein.

The expression “overall carbon intensity value of the renewable hydrogen product gas” is the carbon intensity of the hydrogen product gas, including the entire supply chain upstream and downstream of the present process and the present process itself.

The inventors have realized that, by adjusting the ratio of the secondary fuel to the primary fuel, it is possible to control the carbon intensity value of the cracking process such that the overall carbon intensity value of the renewable hydrogen product gas remains below a pre-determined value. The pre-determined value may be as set out by national regulations. For example, the European Red Il Directive requires that hydrogen labelled as “renewable hydrogen” must have a carbon intensity no greater than 28.2 g CO₂/MJ H₂ and the UK has a limit of 32.9 g CO₂/MJ H₂

The carbon intensity value associated with the conversion of renewable hydrogen to ammonia and the distribution of the ammonia to the site of recovery back into renewable hydrogen may consume 10 to 20 g CO₂/MJ H₂, leaving only a relatively small allowance for the carbon intensity of the recovery process before a regulatory limit is exceeded.

The total carbon intensity value of the process may also be reduced by operating the cracking reactor at a lower temperature in order to increase ammonia slip, reducing conversion of ammonia to hydrogen and increasing the heating value (i.e. calorific value), of the PSA tail gas being used as fuel, which would reduce the amount of primary fuel required, thereby reducing carbon intensity.

The liquid ammonia feed is typically pressurized to a pressure that is greater than 1.1 bar, e.g. at least 5 bar or at least 10 bar. In some embodiments, the liquid ammonia is pressurized to a pressure in a range from about 5 bar to about 50 bar, or in a range from about 10 to about 45 bar, or in a range from about 30 bar to about 40 bar.

The liquid ammonia feed is typically heated to produce heated ammonia at a temperature greater than about 250° C., e.g. in a range from about 350° ° C. to about 800° C., or from about 400° C. to about 600° C. At the pressures in question, the liquid ammonia is typically vaporized completely to form heated ammonia vapour.

The temperature is ultimately determined by the identity of the catalyst, the operating pressure, and the desired “slip”, i.e. the amount of ammonia that passes through the cracking reactor without being cracked. In this regard, the process is typically operated with no more than about 4% slip which would be the amount of slip if the cracking process were operated 5 bar and 350° C. with a close approach to equilibrium. Problems may arise with some construction materials at any appreciable pressure at temperatures above about 700° C.

The cracking reaction takes place in catalyst-filled reactor tubes that are heated by a furnace. However, in theory any heterogeneously catalysed gas reactor could potentially be used for the conversion.

There are a large number of catalysts known in the art as useful for the ammonia cracking reaction and any of these conventional catalysts may be used in this invention.

The primary fuel for the furnace typically comprises methane. The fuel may be pure methane but is more likely natural gas or biogas. In some embodiments, the primary fuel is natural gas or biogas which is supplemented with hydrogen as a secondary fuel, optionally in the form of an ammonia cracked gas. In these embodiments, liquid ammonia may be pumped and cracked to form the cracked gas which is added to the primary fuel.

The first PSA device may operate a PSA cycle or a vacuum swing adsorption (VSA) cycle. A TSA device may be used in combination with the first PSA device, the TSA device to remove ammonia (see U.S. Ser. No. 10/787,367) and the first PSA device to remove nitrogen and produce the hydrogen product. Suitable PSA cycles include any of the cycles disclosed in U.S. Pat. Nos. 9,381,460, 6,379,431 and 8,778,051, the disclosures of which are incorporated herein by reference.

The method may optionally comprise the recycling of any remaining portion of the first PSA tail gas (i.e. any portion not used to supplement the primary fuel) for further processing in the first PSA device. In such embodiments, the process may comprise compressing any remaining portion of the first PSA tail gas to produce a compressed PSA tail gas and recycling the compressed PSA tail gas to the first PSA device for purification with the cracked gas or an ammonia-depleted gas derived therefrom. Recycling the first PSA tail gas in this way can achieve an overall recovery from about 94% to about 96%.

The first PSA tail gas is typically compressed to the pressure of the feed to the first PSA device. The first PSA tail gas is typically pressurized to a pressure that is greater than 1.1 bar, e.g. at least 5 bar or at least 10 bar. In some embodiments, the first PSA tail gas is pressurized to a pressure in a range from about 5 bar to about 50 bar, or in a range from about 10 to about 45 bar, or in a range from about 30 bar to about 40 bar.

The method may optionally comprise purifying any portion of the first PSA tail gas not used to supplement the primary fuel in a second PSA device. In such embodiments, the process may comprise compressing any remaining portion of the first PSA tail gas to produce a compressed PSA tail gas and purifying the compressed PSA tail gas in a second PSA device to produce a second PSA tail gas (i.e. a tail gas derived from the first PSA tail gas) and a second hydrogen gas. The fuel combusted in the furnace may comprise the second PSA tail gas.

In such embodiments, the renewable hydrogen product gas comprises the first hydrogen gas and the second hydrogen gas. Further processing in this way can achieve an overall hydrogen recovery from about 95% to about 97%.

Similarly to the first PSA device, the second PSA device may operate a PSA cycle or a vacuum swing adsorption (VSA) cycle. A TSA device may be used in combination with the second PSA device, the TSA device to remove ammonia the second PSA device to remove nitrogen and produce the hydrogen product. Suitable PSA cycles include any of the cycles disclosed in U.S. Pat. Nos. 9,381,460, 6,379,431 and 8,778,051.

The secondary fuel may comprise the first PSA tail gas, the second PSA tail gas, or a mixture of both the first and second PSA tail gases. In embodiments where the compressed PSA tail gas is recycled to the first PSA device, the remaining portion of the first PSA tail gas is used to supplement the primary fuel is greater than 0 and up to 100%, i.e. the portion cannot be zero. In embodiments where the compressed PSA tail gas is purified in a second PSA device, the remaining portion of the first PSA tail gas used to supplement the primary fuel is from 0 to 100%, i.e. the portion can be zero.

The higher the portion of the first PSA tail gas recycled as secondary fuel (e.g. the higher the ratio of the secondary fuel to the primary fuel), the lower the recovery of hydrogen but also the lower the total carbon intensity value of process and thus the lower the overall carbon intensity value of the renewable hydrogen product. When none of the first PSA tail gas is recycled as secondary fuel (i.e. when only primary fuel and the second PSA tail gas are combusted in the furnace), hydrogen recovery will typically be at its highest value as will the carbon intensity values. If all of the first PSA tail gas is recycled as secondary fuel, hydrogen recovery will be at its lowest value as will the total carbon intensity value of process and the overall carbon intensity of the renewable hydrogen product

A further portion of the first or second PSA tail gases, or a gas derived therefrom, can optionally be separated using a membrane separator to discharge a nitrogen-rich retentate gas and recycle a hydrogen-rich permeate gas for further processing in the PSA devices and/or for mixing into the hydrogen product gas.

Like hydrogen, ammonia is a “fast gas” that readily permeates across membranes used for gas separation. Some membranes, such as those constructed of polyamide or polysulfone polymers, are more tolerant of ammonia. However, some membranes, such as those constructed of polyimide polymers, are less tolerant of ammonia. Therefore, ammonia is typically removed, or its concentration is at least reduced, upstream of the membrane separator.

Ammonia removal may be achieved in several different locations within the process. Prior to separating the PSA tail gas, ammonia may be removed from the PSA tail gas. Alternatively, prior to purifying the cracked gas, ammonia may be removed from the cracked gas. In both cases, the removed ammonia may be recovered and recycled into the ammonia supplied to the catalyst-containing reactor tubes.

Ammonia may be removed from a gas by adsorption (e.g. by TSA) or by absorption in water, e.g. by washing the gas with water in a scrubber. The resultant ammonia-depleted gas and ammonia solution are separated so the ammonia-depleted gas can be further processed without the ammonia causing any difficulties. Ammonia can be recovered from the ammonia solution by stripping in a column. Such a process may be applied to the cracked gas prior to being supplied to the PSA unit or alternatively to the PSA tail gas prior to being supplied to the membrane separator.

According to a second aspect of the present invention, there is provided an apparatus for recovering renewable hydrogen from ammonia that is derived from a source of renewable hydrogen, comprising:
a pump for pressurizing a liquid ammonia feed derived from a source of renewable hydrogen;
at least one heat exchanger in fluid communication with the pump for heating (and optionally vaporizing) the liquid ammonia feed from the pump by heat exchange with one or more hot fluids to produce heated ammonia;
catalyst-containing reactor tubes in fluid communication with the first heat exchanger(s) for cracking heated ammonia from the first heat exchanger(s) to produce cracked gas containing hydrogen gas, nitrogen gas and residual ammonia;
a furnace in thermal communication with the catalyst-containing reactor tubes for combustion of a primary fuel to heat the catalyst-containing reactor tubes to produce flue gas;
a fuel conduit for feeding a primary fuel to the furnace, optionally including passage through the heat exchanger(s);
a fuel valve in the fuel conduit for adjusting the flow of the primary fuel to the furnace;
a flue gas conduit for feeding flue gas to the heat exchanger(s);
a first PSA device in fluid communication with the catalyst-containing reactor tubes for purifying the cracked gas after passage through the heat exchanger(s) to produce a first PSA tail gas and a renewable hydrogen product gas comprising a first hydrogen gas;
a first hydrogen gas conduit for removing the first hydrogen gas from the first PSA device;
a first PSA tail gas conduit for recycling a portion of a first PSA tail gas from the first PSA device to the furnace, optionally including passage through the at least one heat exchanger; and
a PSA tail gas valve in the first PSA tail gas conduit for adjusting the flow of the first PSA tail gas to the furnace;

wherein the apparatus comprises a control system for operating the fuel valve alone, the PSA tail gas valve alone or the fuel valve and the PSA tail gas valve in tandem, to adjust the ratio of the secondary fuel to the primary fuel for combustion in the furnace.

The furnace may be separate from the catalyst-filled reactor tubes although the furnace and the catalyst-filled reactor tubes are preferably integrated within the same unit. In preferred embodiments, a steam methane reforming (SMR) type reactor is used in which the furnace comprises a radiant section through which pass the catalyst-containing reactor tubes.

In some preferred embodiments, the control system adjusts automatically the ratio of the secondary fuel to the primary fuel. The ratio of the fuels is determined by the carbon intensity already allocated by the upstream processing and distribution of the renewable ammonia delivered to the cracking plant and any carbon intensity that may need to be allocated for downstream processing or distribution of the renewable hydrogen product to achieve the goal of not exceeding the pre-determined value of the carbon intensity value of the renewable hydrogen product gas.

A compressor is typically provided downstream of the first PSA device for compressing the first PSA tail gas to produce compressed PSA tail gas. The compressor may consist of one or more stages and cooling will take place between each stage and after the final stage. Water will typically condense out of the compressed PSA tail gas at the interstages or at the aftercooler stage. The aqueous condensate is typically removed after each cooling stage of the compressor and a small amount of ammonia will come out of the first PSA tail gas with this condensate.

Any portion of the first PSA tail gas not recycled from the first PSA device to the furnace may be recycled to the first PSA device for further purification with the cracked gas or an ammonia-depleted gas derived therefrom. In such embodiments, the apparatus comprises:
a compressor in fluid communication with the first PSA device for compressing the first PSA tail gas to produce compressed PSA tail gas; and
a recycle conduit for recycling the compressed PSA tail gas to the first PSA device.

Any portion of the first PSA tail gas not recycled from the first PSA device to the furnace may optionally be purified in a second PSA device. In such embodiments, the apparatus comprises:
a compressor in fluid communication with the first PSA device for compressing the first PSA tail gas to produce compressed PSA tail gas;
a second PSA device in fluid communication with the compressor for purifying the compressed PSA tail gas to produce a second PSA tail gas and a second hydrogen gas;
a second hydrogen gas conduit for removing the second hydrogen gas from the second PSA device; and
a second PSA tail gas conduit for removing the second PSA tail gas from the second PSA device.

In these embodiments, the first and second hydrogen gas conduits may combine to form a renewable hydrogen product gas conduit.

The secondary PSA tail gas conduit typically recycles the second PSA tail gas from the second PSA device to the furnace, optionally after passage through the heat exchanger(s).

The invention will now be described in detail with reference to the following figures.

### BRIEF DESCRIPTION OF THE DRAWINGS

FIG. 1 is a process flow diagram of a first reference example of an ammonia cracking process to produce hydrogen;

FIG. 2 is a process flow diagram of another reference example based on the ammonia cracking process of FIG. 1 in which no hydrogen product is used as fuel

FIG. 3 is a process flow diagram of a further reference example based on the ammonia cracking process of FIGS. 1 & 2 in which only PSA tail gas is used as fuel;

FIG. 4 is a process flow diagram of a first embodiment of a process for recovering renewable hydrogen from ammonia that is derived from a source of renewable hydrogen according to the present invention;

FIG. 5 is a process flow diagram of a second embodiment of a process for recovering renewable hydrogen from ammonia that is derived from a source of renewable hydrogen according to the present invention; and

FIG. 6 is a graph showing carbon intensity of the renewable hydrogen product gas and hydrogen recovery as a function of the percentage of the first PSA tail gas recycled as fuel.

### DETAILED DESCRIPTION OF THE INVENTION

A process is described herein for producing hydrogen by cracking ammonia. The process has particular application to producing so-called “green” hydrogen which is hydrogen created using renewable energy instead of fossil fuels. In this case, the ammonia is typically produced by electrolyzing water using electricity generated from renewable energy, such as wind and/or solar energy, to produce hydrogen which is then reacted catalytically with nitrogen (Haber process) to produce the ammonia which is more easily transported than hydrogen. After reaching its destination, the ammonia is then cracked to regenerate the hydrogen.

In this inventive process, the heat required for the reaction is typically provided by combustion of PSA tail gas (which usually contains some amount of residual hydrogen and ammonia) in the furnace. If the PSA tail-gas has insufficient heating value than either vaporised ammonia, a portion of the product hydrogen, or an alternative fuel may be used with the tail-gas as a trim fuel.

In practice, natural gas could be used as a trim fuel, together with the PSA tail gas, as is practiced in SMRs for hydrogen. However, with the desire to maintain the “green” or renewable credentials of the hydrogen so produced, there is an incentive to use a “renewable fuel”. This can be the cracked “renewable” ammonia, the ammonia itself, or another renewable energy source, such as biogas, or indeed electric heating whether the electricity is itself from a renewable source, in this case local to the cracking process as opposed to the renewable electricity used to generate the hydrogen which has been transported in the form of ammonia.

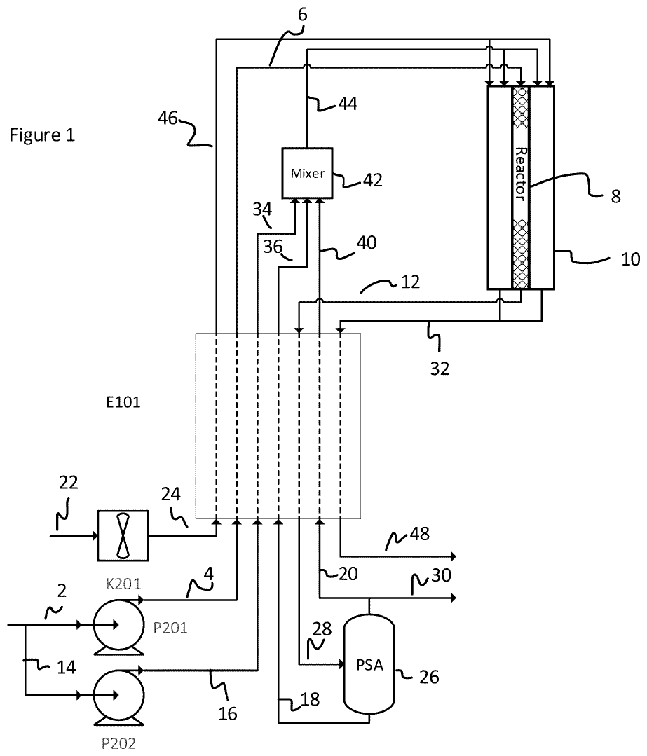

A reference example of the process is shown in FIG. 1. The process takes liquid ammonia from storage (not shown). The ammonia to be cracked (line 2) is pumped (pump P201) as liquid to a pressure greater than the desired cracking pressure (see GB1142941). The reaction pressure is a compromise between operating pressure and conversion according to Le Chatelier's principle. There is an incentive to operate the reactor (8) at higher pressure because pumping liquid ammonia requires less power and capital than compressing the product hydrogen.

The pressurised liquid ammonia (line 4) is then heated, vaporised (if it is below its critical pressure) and heated further, up to a temperature of greater than 250° C. via a heat exchanger (E101) using the heat available in the cracked gas leaving the reaction tubes and the flue gas from the furnace. In the figure, the heat exchanger (E101) is shown as one heat exchanger but, in practice, it will be a series of heat exchangers in a network.

The initial heating and vaporization of the pressurized liquid ammonia may alternatively take place against an alternative heat source, such as cooling water or ambient air. Typical reaction temperatures are greater than 500° C. (see U.S. Pat. No. 2,601,221), palladium-based systems can run at 600° C. and 10 bar, whereas RenCat's metal oxide-based system runs at less than 300° C. and 1 bar. (See https://www.ammoniaenergy.org/articles/ammonia-cracking-to-high-purity-hydrogen-for-pem-fuel-cells-in-denmark/). The operating pressure of the cracker is typically an optimization of several factors. Cracking of ammonia into hydrogen and nitrogen is favored by low pressure but other factors favor higher pressure, such as power consumption (which is minimized by pumping the feed ammonia rather than compressing the product hydrogen), and the PSA size (which is smaller at higher pressure).

The hot ammonia (line 6) enters reaction tubes of a reactor (8) at the desired pressure where additional heat is provided by the furnace (10) to crack the ammonia into nitrogen and hydrogen. The resulting mixture of residual ammonia, hydrogen and nitrogen exits (line 12) the reaction tubes (8) of the reactor at the reaction temperature and pressure. The reaction products are cooled in a heat exchanger (E101) against a combination of feed ammonia (from line 4), furnace fuel (in this case pumped ammonia from line 14, pump P202 and line 16; PSA tail gas from line 18; and product hydrogen to be used as fuel in line 20) and combustion air (from line 22, fan K201 and line 24) to reduce the temperature as close as possible to that required for the inlet of a PSA device (26). Any residual heat in the cracked gas mixture (line 28) is removed in a water cooler (not shown) to achieve an inlet temperature to the PSA device (26) of in a range from about 20° C. to about 60° C., e.g. about 50° C.

The PSA product (line 30) is pure hydrogen compliant with ISO standard 14687—Hydrogen Fuel Quality—with residual ammonia<0.1 ppmv and nitrogen<300 ppmv—at approximately the reaction pressure. The product hydrogen (line 30) is further compressed (not shown) for filling into tube trailers (not shown) for transport or it may be liquefied in a hydrogen liquefier (not shown) after any required compression. The PSA tail gas (line 18) or “purge gas” from the PSA device (26) is shown as being heated via the heat exchanger E101, using the cracked gas (line 12) leaving the reaction tubes of the reactor (8) or furnace flue gas (line 32), before being sent (in line 36) to the furnace as a combustion fuel. However, the PSA tail gas (line 18) may be fed directly to the furnace (10) without heating). Alternatively, the PSA tail gas may be preheated by an intermediate fluid, so as to allow a lower pressure for the PSA tail gas which increases hydrogen recovery.

The resultant warmed ammonia fuel (line 34) and warmed hydrogen (line 40) are depicted as combined with the (optionally) warmed PSA tail gas (line 36) in a mixer (42) to produce a combined fuel which is fed (line 44) to the furnace (10) for combustion to generate the flue gas (line 32 and, after cooling in E101, line 48). However, it should be noted that one or more of the fuels could be fed directly to the furnace without prior mixing. The warmed air (for combustion of the fuel) is fed to the furnace (10) in line 46.

One of the aims of preferred embodiments of the present process is to maximise the amount of hydrogen generated by cracking the renewable ammonia. That means minimising the amount of hydrogen used as fuel, or ammonia if ammonia were to be used as a fuel directly. Therefore, heat integration is important so as to use the hot flue gas and cracked gas appropriately, for instance to preheat air (line 24) and ammonia (line 4) to the cracker as this reduces the amount of “fuel” to be used in the burners of the furnace (10). This leads to higher hydrogen recovery as less of the hydrogen is lost in the furnace flue gas (lines 32 & 48) as water. Therefore, steam generation, for instance, should be minimised in favour of intra-process heat integration.

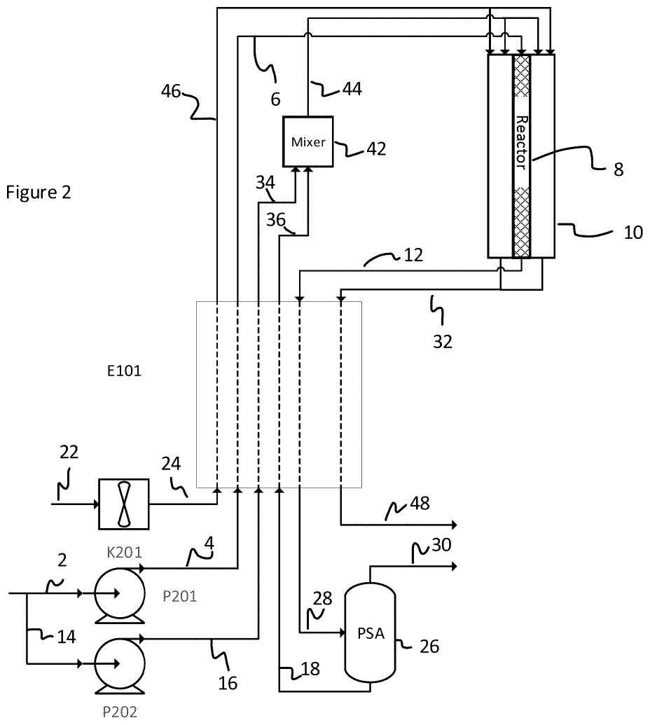

FIG. 1 shows ammonia provided as fuel (lines 34 & 44) and feed (line 6) and it also shows product hydrogen as fuel (lines 40 & 44)—in practice, it is likely only one of these streams would be used as fuel. In this regard, FIG. 2 depicts a similar process to that of FIG. 1 in which ammonia is used as a fuel (line 34) but not product hydrogen. All other features of the process depicted in FIG. 2 are the same as in FIG. 1 and the common features have been given the same reference numerals.

The inventors are aware that stable combustion of ammonia is facilitated if hydrogen is also used as a fuel, particularly at start-up and warm-up.

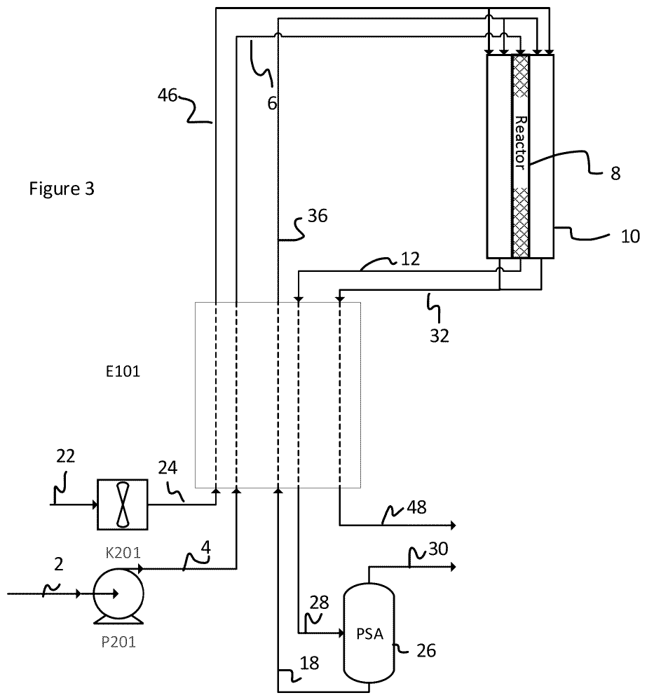

FIG. 3 depicts a process similar to that depicted in FIG. 2. In this process, the recovery of hydrogen (line 30) from the PSA may be adjusted to provide a tail gas (line 18) which, when burned, will provide all the heat required by the process, thus eliminating the need for a trim fuel. All other features of the process depicted in FIG. 3 are the same as in FIG. 1 and the common features have been given the same reference numerals.

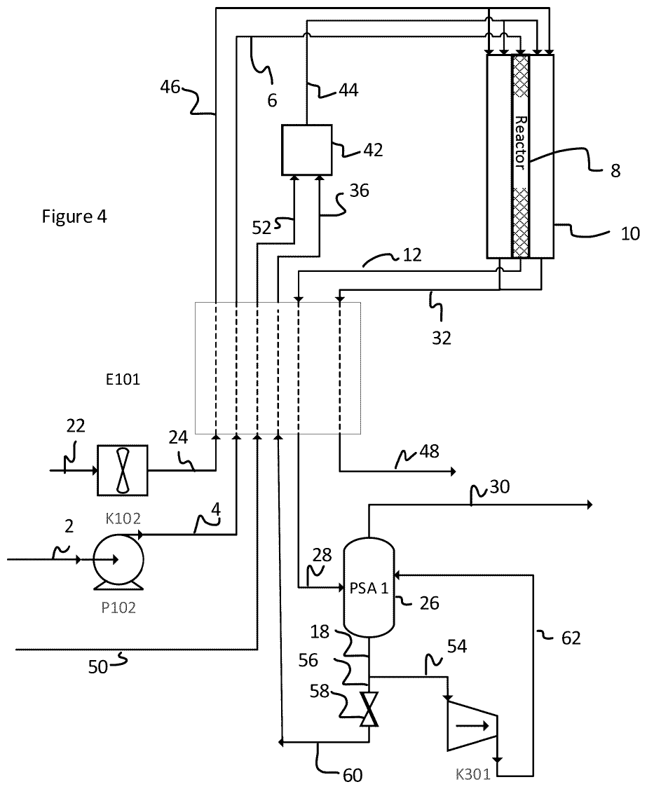

Should there be a viable alternative source of renewable energy for the cracking reactions, as discussed above, one could consider recovering hydrogen from the PSA tail gas to increase the net hydrogen production from the process in addition to the hydrogen produced from the PSA. Such a process could use membranes, which have a selective layer that is readily permeable to hydrogen but relatively impermeable to nitrogen, to separate hydrogen from the nitrogen rich PSA tail gas stream (FIG. 4).

Ammonia may need to be removed particularly but not exclusively if membranes are being used as part of the separation process since membrane material can be intolerant of high concentrations of ammonia and ammonia is a fast gas and would permeate with the hydrogen so would accumulate in the process if not removed. Ammonia may be removed for instance by a water wash or other well-known technology for ammonia removal, upstream of the membrane. Ammonia may be recovered from an aqueous ammonia solution generated in the water wash using a stripping column and the recovered ammonia could be recycled to the feed to the cracking reactor. This could theoretically increase the hydrogen recovery from the process up to 100%. Recovering ammonia from the cracked gas simplifies the hydrogen purification steps, may increase the recovery of hydrogen from the ammonia if the separated ammonia is recovered as feed, and also removes ammonia from the feed to the burners, eliminating concerns over production of NOx caused by burning ammonia.

Water may also need to be removed from the feed ammonia to prevent damage to the ammonia cracking catalyst. Typically, ammonia has small quantities of water added to it to prevent stress corrosion cracking in vessels during shipping and storage. This might need to be removed. However, the water removal can be incorporated into the stripping column mentioned above. The ammonia would be evaporated at the required pressure, taking care in the design of the evaporator to ensure that the water was also carried through to the stripping column with the evaporator ammonia. This mostly vapor phase ammonia enters a mid-point of the column and pure ammonia leaves through the top of the column. The column has a partial condenser (condenses only enough liquid for the reflux) and the overhead vapor contains the feed ammonia (free of water) plus the ammonia recovered from the cracker gas stream.

It may be more energy efficient to feed the cracked gas first to a membrane to produce a hydrogen-enriched permeate stream and a nitrogen-rich retentate stream that could be vented. The hydrogen-enriched permeate can be further purified in the PSA. A second membrane could be added to the PSA tail gas stream to further boost the overall hydrogen recovery. This configuration would greatly reduce the tail-gas compressor size.

The use of a membrane separator to increase hydrogen recovery allows the nitrogen to be vented from the process without passing through the combustion section of the process. In processes where the nitrogen stream is at pressure, it would be beneficial to expand the nitrogen to atmospheric pressure before venting to recover power through an expansion turbine. It would increase the amount of power recovered if the pressurized nitrogen were to be heated before expansion using heat available in the flue gas or cracked gas stream.

FIG. 4 depicts a process according to a first embodiment of the present invention in which the primary fuel is supplemented with a secondary fuel comprising a portion of the first PSA tail gas. The features of the process in FIG. 4 that are common to the processes of FIGS. 1 to 3 have been given the same reference numerals. The following is a discussion of the new features in FIG. 4.

A primary fuel (line 50) is warmed in the heat exchange (E101) and combined with the optionally warmed PSA tail gas (line 36) to produce a combined fuel which is fed (line 44) to the furnace (10) for combustion to heat the catalyst-filled tubes of the cracking reactor (8) and to generate the flue gas (line 32 and, after cooling in E101 line 48). The warmed air is fed to the furnace (10) in line 46. The primary fuel (line 50) and PSA tail gas (line 36) can be fed to the furnace separately without mixing (not shown).

The cooled cracked gas (line 28) is fed to a first PSA device (26). The cracked gas is separated to form the hydrogen product (line 30) and tail gas (line 18). A first part of the tail gas (line 54) from the first PSA device (26) is compressed in a compressor (K301) to produce compressed PSA tail gas (line 62). The compressed PSA tail gas (line 62) is recycled back to the first PSA device (26) for purification with the cooled cracked gas (28) or the ammonia-depleted gas derived therefrom.

A second part of the first PSA tail gas (line 56) is fed through PSA tail gas valve (58) which controls the portion of the first PSA tail gas (60) that is fed back to the furnace (optionally via heat exchanger (E101) and mixer (42)). If all of the first PSA tail gas is fed back to the furnace, the hydrogen recovery at its lowest value (typically about 50%). If about 50% of the first PSA tail gas is recycled as fuel, a hydrogen recovery of about 95% can be achieved.

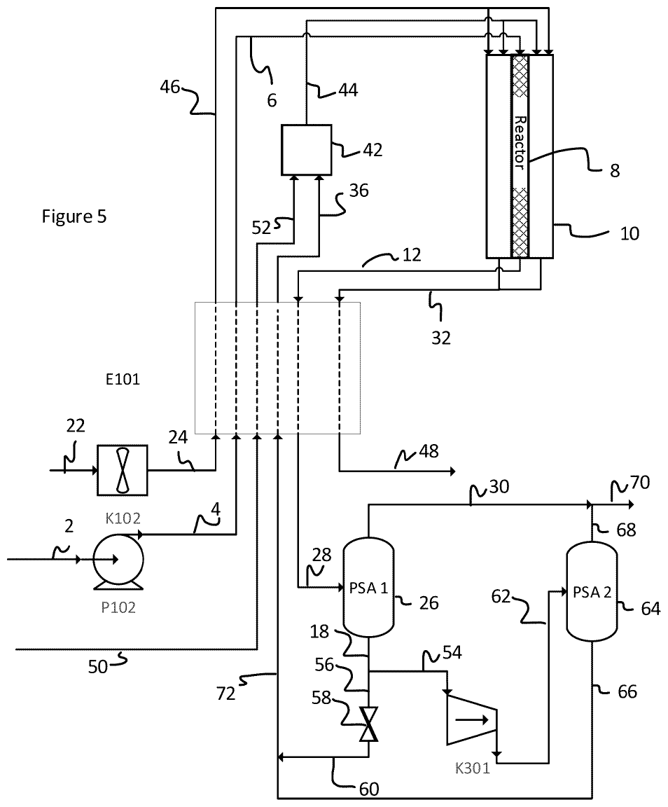

Alternatively, as shown in FIG. 5, the compressed PSA tail gas (line 62) can be fed to a second PSA device (64). The product hydrogen from the second PSA device (line 68) is combined with the hydrogen product (line 30) from the first PSA device (26) to form a combined hydrogen product gas (line 70). The portion (line 60) of first PSA tail gas being used as fuel is combined with the PSA tail gas (line 66) from the second PSA device (64) to produce a combined PSA tail gas (line 72). Similarly to the processes of FIG. 1 and FIG. 2, the combined PSA tail gas (line 66) can be heated via the heat exchanger E101, using the cracked gas (line 12) leaving the reaction tubes or furnace flue gas (line 32), before being sent (in line 36) to the furnace as a combustion fuel. However, the combined PSA tail gas (line 72) may be fed directly to the furnace (10) without heating (not shown).

The invention will now be illustrated with reference to the following Invention Examples and by comparison with the following Reference Examples. For the purposes of the simulations, both the Invention Examples and the Reference Examples assume an equilibrium for the cracking reaction at 11 bar and 500° C.

### Reference Example 1

The process depicted in FIG. 2 has been simulated by computer (Aspen Plus, ver. 10, Aspen Technology, Inc.) and the results are depicted in Table 1.

TABLE 1

| | | Fluid Description | | | | | | | |
|---|---|---|---|---|---|---|---|---|---|
| | | | | | | Cooled | | | |
| | | | | | | Crude | | | |
| | | Feed | Fuel | | Cracked | Hydrogen | PSA | Hydrogen | Cooled |
| | | Ammonia | Ammonia | Air | Ammonia | to PSA | Offgas | Product | Flue Gas |
| | | Stream number | | | | | | | |
| Composition | | 2 | 14 | 22 | 12 | 28 | 18 | 30 | 48 |
| Hydrogen | mol % | 0.0000 | 0.0000 | 0.0000 | 73.8791 | 73.8791 | 31.8188 | 100.0000 | 0.0000 |
| Nitrogen: | mol % | 0.0000 | 0.0000 | 76.6000 | 24.6264 | 24.6264 | 64.2803 | 0.0000 | 75.6694 |
| Ammonia | mol % | 99.8100 | 99.8100 | 0.0000 | 1.3981 | 1.3981 | 3.6492 | 0.0000 | 0.0000 |
| Water | mol % | 0.1900 | 0.1900 | 1.8500 | 0.0964 | 0.0964 | 0.2517 | 0.0000 | 22.7084 |
| Oxygen | mol % | 0.0000 | 0.0000 | 20.6000 | 0.0000 | 0.0000 | 0.0000 | 0.0000 | 1.0762 |
| Argon | mol % | 0.0000 | 0.0000 | 0.9200 | 0.0000 | 0.0000 | 0.0000 | 0.0000 | 0.5287 |
| Carbon Dioxide | mol % | 0.0000 | 0.0000 | 0.0300 | 0.0000 | 0.0000 | 0.0000 | 0.0000 | 0.0172 |
| Methane | mol % | 0.0000 | 0.0000 | 0.0000 | 0.0000 | 0.0000 | 0.0000 | 0.0000 | 0.0000 |
| Ethane | mol % | 0.0000 | 0.0000 | 0.0000 | 0.0000 | 0.0000 | 0.0000 | 0.0000 | 0.0000 |
| Flowrate (total) | kmol/hr | 17.0021 | 0.8500 | 16.1778 | 33.5035 | 33.5035 | 12.8355 | 20.6680 | 28.1505 |
| Pressure | bar (abs) | 1.0000 | 1.0000 | 1.0133 | 11.0000 | 11.0000 | 1.4000 | 10.5000 | 1.0500 |
| Temperature | ° C. | −33.6938 | −33.6938 | 20.0000 | 500.0000 | 50.0000 | 40.0000 | 49.9922 | 117.4344 |

In this Reference Example, hydrogen recovery from the ammonia is 77.18% with the PSA recovery at 83.5%. The total power of the ammonia feed pump (P201), the ammonia fuel pump (P202) and the air fan (K201) is about 1.36 kW.

### Reference Example 2

The process depicted in FIG. 3 has been simulated by computer (Aspen Plus, ver. 10) and the results are depicted in Table 2.

TABLE 2

| | | Fluid Description | | | | | | |
|---|---|---|---|---|---|---|---|---|
| | | | | | Cooled | | | |
| | | | | | Crude | | | |
| | | Feed | | Cracked | Hydrogen | PSA | Hydrogen | Cooled |
| | | Ammonia | Air | Ammonia | to PSA | Offgas | Product | Flue Gas |
| | | Stream number | | | | | | |
| Composition | | 2 | 22 | 12 | 28 | 18 | 30 | 48 |
| Hydrogen | mol % | 0.0000 | 0.0000 | 73.8791 | 73.8791 | 36.8306 | 100.0000 | 0.0000 |
| Nitrogen | mol % | 0.0000 | 76.6000 | 24.6264 | 24.6264 | 59.5552 | 0.0000 | 75.6244 |
| Ammonia | mol % | 99.8100 | 0.0000 | 1.3981 | 1.3981 | 3.3810 | 0.0000 | 0.0000 |
| Water | mol % | 0.1900 | 1.8500 | 0.0964 | 0.0964 | 0.2332 | 0.0000 | 22.7504 |
| Oxygen | mol % | 0.0000 | 20.6000 | 0.0000 | 0.0000 | 0.0000 | 0.0000 | 1.0783 |
| Argon | mol % | 0.0000 | 0.9200 | 0.0000 | 0.0000 | 0.0000 | 0.0000 | 0.5297 |
| Carbon Dioxide | mol % | 0.0000 | 0.0300 | 0.0000 | 0.0000 | 0.0000 | 0.0000 | 0.0173 |
| Methane | mol % | 0.0000 | 0.0000 | 0.0000 | 0.0000 | 0.0000 | 0.0000 | 0.0000 |
| Ethane | mol % | 0.0000 | 0.0000 | 0.0000 | 0.0000 | 0.0000 | 0.0000 | 0.0000 |
| Flowrate (total) | kmol/hr | 17.8832 | 16.3022 | 35.2398 | 35.2398 | 14.5719 | 20.6680 | 28.3138 |
| Pressure | bar (abs) | 1.0000 | 1.0133 | 11.0000 | 11.0000 | 1.4000 | 10.5000 | 1.0500 |
| Temperature | ° C. | −33.6938 | 20.0000 | 500.0000 | 50.0000 | 40.0000 | 49.9922 | 119.1601 |

In this Reference Example, hydrogen recovery from the ammonia is 77.05% with the PSA recovery at 79.4%. The total power of the ammonia feed pump (P201) and the air fan (K201) is about 1.37 kW.

### Invention Example 1

The process depicted in FIG. 5 has been simulated by computer (Aspen Plus, ver. 10) and the results are depicted in Table 3.

TABLE 3

| | | Fluid Description | | | | | | | | |
|---|---|---|---|---|---|---|---|---|---|---|
| | | | | | | Cooled | | | | |
| | | | | | | crude | | | | |
| | | Feed | Natural | | Cracked | H₂ to | PSA1 | PSA2 | H2 | Flue |
| | | Ammonia | gas fuel | Air | Ammonia | PSA1 | Offgas | Offgas | Product | Gas |
| | | Stream number | | | | | | | | |
| Composition | | 2 | 50 | 22 | 12 | 26 | 54 | 72 | 70 | 42 |
| Hydrogen | mol % | 0.00 | 0.00 | 0.00 | 73.88 | 73.88 | 8.54 | 8.54 | 100.00 | 0.00 |
| Nisogen | mol % | 0.00 | 1.00 | 78.80 | 24.63 | 24.63 | 56.23 | 56.23 | 0.00 | 77.80 |
| Ammonia | mol % | 99.81 | 0.00 | 0.00 | 1.40 | 1.40 | 4.90 | 4.90 | 0.00 | 0.00 |
| Water | mol % | 0.19 | 0.00 | 1.85 | 0.10 | 0.10 | 0.34 | 0.34 | 0.00 | 15.69 |
| Oxygen | mol % | 0.00 | 0.00 | 20.80 | 0.00 | 0.00 | 0.00 | 0.00 | 0.00 | 1.15 |
| Argon | mol % | 0.00 | 0.00 | 0.92 | 0.00 | 0.00 | 0.00 | 0.00 | 0.00 | 0.58 |
| Carbon Dioxide | mol % | 0.00 | 0.50 | 0.03 | 0.00 | 0.00 | 0.00 | 0.00 | 0.00 | 4.74 |
| I&ethexe | mol % | 0.00 | 94.25 | 0.00 | 0.00 | 0.00 | 0.00 | 0.00 | 0.00 | 0.00 |
| Ethane | mol % | 0.00 | 4.21 | 0.00 | 0.00 | 0.00 | 0.00 | 0.00 | 0.00 | 0.00 |
| flowrate (total) | kmol/hr | 14.68 | 1.15 | 15.99 | 28.93 | 28.93 | 6.26 | 6.28 | 20.67 | 25.18 |
| Pressure | bar (abs) | 1.00 | 10.11 | 1.01 | 11.00 | 11.00 | 1.36 | 3.30 | 10.50 | 1.05 |
| Temperature | ° C. | −33.69 | 30.00 | 20.00 | 500.00 | 50.00 | 40.00 | 40.00 | 47.26 | 142.27 |

In this Invention Example, hydrogen recovery from the ammonia is 93.85%. In this Invention Example, the PSA tail gas valve is closed so all of the first PSA tail gas is recycled for further purification in the second PSA device. The second PSA tail gas from the second PSA device is recycled to the furnace as secondary fuel. This is provided as a starting point to show the effect that recycling the tail gas from the first PSA device to fuel has on the carbon intensity value of the process.

### Invention Example 2

The process depicted in FIG. 5 has been simulated by computer (Aspen Plus, ver. 10) and the results are depicted in Table 4.

TABLE 4

| Fluid Description | | | | | | | |
|---|---|---|---|---|---|---|---|
| Percentage | | | | | CO₂ | | |
| of PSA1 | | | | CO₂ | leaving | | |
| Offgas | | | | entering | with flue | H₂ | |
| diverted | Hydrogen | Feed | | with Air | gas | Recovered | Carbon |
| through | Product, | Ammonia | Fuel | Stream 22 | Stream 48 | from | Intensity |
| valve 58 | Stream 70 | Stream 2 | Stream 50 | kg/hr | kg/hr | stream 28 | gCO₂/MJ H₂ |
| 0% | 20.668 | 14.653 | 19.438 | 0.211 | 52.472 | 94.0% | 10.45 |
| 10% | 20.668 | 14.856 | 18.205 | 0.211 | 49.156 | 92.7% | 9.79 |
| 20% | 20.668 | 15.065 | 16.937 | 0.212 | 45.747 | 91.5% | 9.11 |
| 30% | 20.668 | 15.279 | 15.633 | 0.212 | 42.241 | 90.2% | 8.41 |
| 40% | 20.668 | 15.500 | 14.291 | 0.212 | 38.634 | 89.9% | 7.69 |
| 50% | 20.668 | 15.727 | 12.910 | 0.213 | 34.921 | 87.6% | 6.94 |
| 60% | 20.668 | 15.961 | 11.488 | 0.213 | 31.098 | 86.3% | 6.18 |
| 70% | 20.668 | 16.201 | 10.022 | 0.213 | 27.159 | 85.0% | 5.39 |
| 80% | 20.668 | 16.450 | 8.512 | 0.213 | 23.100 | 83.8% | 4.58 |
| 90% | 20.668 | 16.706 | 6.955 | 0.214 | 18.914 | 82.5% | 3.74 |
| 100% | 20.668 | 16.970 | 5.349 | 0.214 | 14.597 | 81.2% | 2.88 |

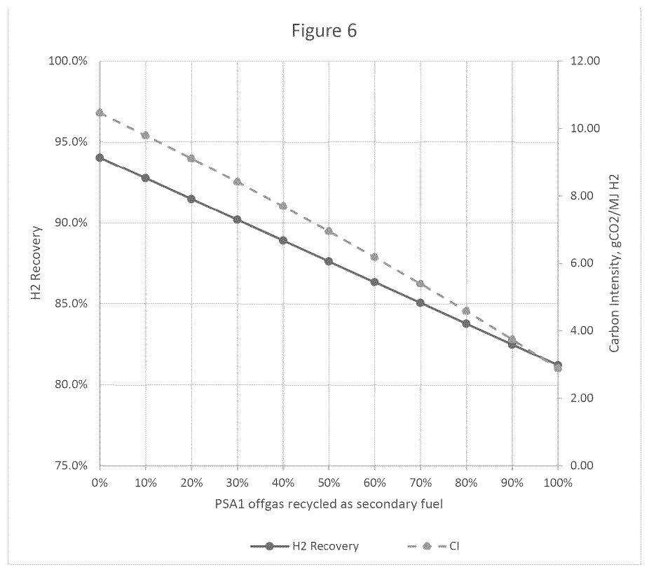

In this Invention Example, the portion of the first PSA tail gas diverted through the fuel valve and recycled as secondary fuel is varied between 0% and 100%. In this Example, hydrogen production was kept constant and the ammonia feed rate through line 2 was increased to compensate for the reduction in hydrogen recovery. The data in FIG. 6 show that increasing the amount of the first PSA tail gas recycled as secondary fuel reduces the hydrogen recovery but also reduces the carbon intensity of renewable hydrogen product as less primary fuel is required.

These data demonstrate the impact of the combustion process on the carbon intensity value of the renewable hydrogen product. This data also demonstrates that the carbon intensity value of the renewable hydrogen product can be controlled by varying the ratio of the primary fuel to the secondary fuel.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1. A process for recovering renewable hydrogen from ammonia that is derived from a source of renewable hydrogen, comprising:
providing a liquid ammonia feed derived from a source of renewable hydrogen;
pressurizing the liquid ammonia feed;
heating (and optionally vaporizing) the liquid ammonia feed by heat exchange with one or more hot fluids to produce heated ammonia;
combusting a primary fuel in a furnace to heat catalyst-containing reactor tubes and to form a flue gas;
supplying the heated ammonia to the catalyst-containing reactor tubes to cause cracking of the ammonia into a cracked gas containing hydrogen gas, nitrogen gas and residual ammonia; and
purifying the cracked gas, or an ammonia-depleted gas derived therefrom, in a first PSA device to produce a first PSA tail gas and a renewable hydrogen product gas comprising a first hydrogen gas;
wherein the one or more hot fluids comprise the flue gas and/or the cracked gas;
wherein the primary fuel is supplemented as required with a secondary fuel comprising at least a portion of the first PSA tail gas and/or a PSA tail gas derived therefrom,
wherein hydrogen is recovered from any remaining portion of the first PSA tail gas to the renewable hydrogen product gas; and
wherein the total carbon intensity value of the process is varied by adjusting the ratio of the secondary fuel to the primary fuel such that the overall carbon intensity value of the renewable hydrogen product gas remains below a pre-determined value.

2. A process according to claim 1 comprising:
compressing the remaining portion of the first PSA tail gas to produce a compressed PSA tail gas; and
recycling the compressed PSA tail gas to the first PSA device for purification with the cracked gas or the ammonia-depleted gas derived therefrom.

3. A process according to claim 1 comprising:
compressing the remaining portion of the first PSA tail gas to produce a compressed PSA tail gas; and
purifying the compressed PSA tail gas in a second PSA device to produce a second PSA tail gas and a second hydrogen gas.

4. A process according to claim 3, wherein the secondary fuel comprises the second PSA tail gas.

5. A process according to claim 3, wherein the renewable hydrogen product gas comprises the first hydrogen gas and the second hydrogen gas.

6. A process according to claim 1, wherein the primary fuel is supplemented by greater than 0 to 100% of the first PSA tail gas.

7. A process according to claim 3, wherein the primary fuel is supplemented with from 0 to 100% of the first PSA tail gas.

8. A process according to claim 1, wherein the primary fuel comprises one or more of ammonia, hydrogen and methane.

9. A process according to claim 1, wherein the primary fuel is natural gas or biogas.

10. An apparatus for recovering renewable hydrogen from ammonia that is derived from a source of renewable hydrogen, comprising:
a pump for pressurizing a liquid ammonia feed derived from a source of renewable hydrogen;
at least one heat exchanger in fluid communication with the pump for heating (and optionally vaporizing) the liquid ammonia feed from the pump by heat exchange with one or more hot fluids to produce heated ammonia;
catalyst-containing reactor tubes in fluid communication with the first heat exchanger(s) for cracking heated ammonia from the first heat exchanger(s) to produce cracked gas containing hydrogen gas, nitrogen gas and residual ammonia;
a furnace in thermal communication with the catalyst-containing reactor tubes for combustion of a primary fuel to heat the catalyst-containing reactor tubes to produce flue gas;
a fuel conduit for feeding a primary fuel to the furnace, optionally including passage through the heat exchanger(s);
a fuel valve in the fuel conduit for adjusting the flow of the primary fuel to the furnace;
a flue gas conduit for feeding flue gas to the heat exchanger(s);
a first PSA device in fluid communication with the catalyst-containing reactor tubes for purifying the cracked gas after passage through the heat exchanger(s) to produce a first PSA tail gas and a renewable hydrogen product gas comprising a first hydrogen gas;
a first hydrogen gas conduit for removing the first hydrogen gas from the first PSA device;
a first PSA tail gas conduit for recycling a portion of a first PSA tail gas from the first PSA device to the furnace, optionally after passage through the heat exchanger(s); and
a PSA tail gas valve in the first PSA tail gas conduit for adjusting the flow of the first PSA tail gas to the furnace,
wherein the apparatus comprises a control system for operating the fuel valve alone, the PSA tail gas valve alone or the fuel valve and the PSA tail gas valve in tandem, to adjust the ratio of the secondary fuel to the primary fuel for combustion in the furnace.

11. An apparatus according to claim 10, wherein the control system adjusts automatically the ratio of the secondary fuel to the primary fuel.

12. An apparatus according to claim 10 comprising:
a compressor in fluid communication with the first PSA device for compressing the first PSA tail gas to produce compressed PSA tail gas; and
a recycle conduit for recycling the compressed PSA tail gas to the first PSA device.

13. An apparatus according to claim 10 comprising:
a compressor in fluid communication with the first PSA device for compressing the first PSA tail gas to produce compressed PSA tail gas;
a second PSA device in fluid communication with the compressor for purifying the compressed PSA tail gas to produce a second PSA tail gas and a second hydrogen gas;
a second hydrogen gas conduit for removing the second hydrogen gas from the second PSA device; and
a second PSA tail gas conduit for removing the second PSA tail gas from the second PSA device.

14. An apparatus according to claim 13, wherein the first and second hydrogen gas conduits combine to form a renewable hydrogen product gas conduit.

15. An apparatus according to claim 13, wherein the second PSA tail gas conduit recycles the second PSA tail gas from the second PSA device to the furnace, optionally after passage through the heat exchanger(s).
